(19) United States
(12) Patent Application Publication
(10) Pub. No.: US 2016/0316249 A1
(43) Pub. Date: Oct. 27, 2016

(54) SYSTEM FOR PROVIDING A VIEW OF AN EVENT FROM A DISTANCE

(71) Applicant: ASHCORP TECHNOLOGIES, LLC, Kemp, TX (US)

(72) Inventor: Ashley Brian Smith, Kemp, TX (US)

(73) Assignee: ASHCORP TECHNOLOGIES, LLC, Kemp, TX (US)

(21) Appl. No.: 14/812,880

(22) Filed: Jul. 29, 2015

Related U.S. Application Data
(60) Provisional application No. 62/031,437, filed on Jul. 31, 2014.
(60) Provisional application No. 62/156,266, filed on May 3, 2015.

(51) Int. Cl. H04N 21/4223; H04N 21/2187; H04N 5/232; H04N 21/414

(52) U.S. Cl. CPC H04N 21/4223; H04N 21/41407; H04N 21/2187; H04N 5/23238

(57) ABSTRACT

According to an embodiment of the disclosure, a system for displaying streamed video from a distance comprises one or more capturing devices and one or more servers. Each of the one more capturing device have a plurality of sensors configured to capture light used in forming image frames for a video stream. The plurality of sensors are arranged around a shape to capture the light at different focal points and at different angles. The one or more servers are configured to receive light data from the one or more capturing devices, and to provide a dynamically selected subset of the light data captured by the plurality of sensors to a remote end user as a stream of image frames for a video stream. The subset of the light data provided by the one more servers at a particular instance depend on selections from the end user.

### CROSS-REFERENCE TO RELATED APPPLICATIONS

The present application is related to U.S. Provisional Patent Application No. 62/031,437, which was filed on Jul. 31, 2014, and entitled “PANORAMIC IMAGING SYSTEM AND METHOD OF USING SAME” and U.S. Provisional Patent Application No. 62/156,266, which was filed on May 3, 2015, and entitled “SYSTEM FOR PROVIDING A VIEW OF AN EVENT FROM A DISTANCE.” U.S. Provisional Patent Application Nos. 62/031,437 and 62/156,266 are hereby incorporated by reference into the present application as if fully set forth herein. The present application hereby claims priority under 35 U.S.C. §119(e) to U.S. Provisional Patent Nos. 62/031,437 and 62/156,266.

### TECHNICAL FIELD

This disclosure is generally directed to monitoring systems. More specifically, this disclosure is directed to a wristband and application to allow one person to monitor another.

### BACKGROUND

Not everyone gets the much envied 50-yard line tickets at a college or professional football game. And, not everyone has the time in their schedule to attend the wedding of a friend of loved ones or attend a concert from his or her favorite band. Moreover, the videos of such events don't actually substitute for actually being at the event. The viewer of such videos must watch what the cameraman (or producer) viewed as being important.

### SUMMARY OF THE DISCLOSURE

According to an embodiment of the disclosure, a system for displaying streamed video from a distance comprises one or more capturing devices and one or more servers. Each of the one more capturing device have a plurality of sensors configured to capture light used in forming image frames for a video stream. The plurality of sensors are arranged around a shape to capture the light at different focal points and at different angles. The one or more servers are configured to receive light data from the one or more capturing devices, and to provide a dynamically selected subset of the light data captured by the plurality of sensors to a remote end user as a stream of image frames for a video stream. The subset of the light data provided by the one more servers at a particular instance depend on selections from the end user.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### BRIEF DESCRIPTION OF THE DRAWINGS

For a more complete understanding of this disclosure and its features, reference is now made to the following description, taken in conjunction with the accompanying drawings, in which:

FIG. 1 is a simplified block diagram illustrative of a communication system that can be utilized to facilitate communication between endpoints through a communication network 130, according to particular embodiments of the disclosure;

FIG. 2 is a simplified system, according to an embodiment of the disclosure;

FIG. 3 provides non-limiting examples of glasses, according to an embodiment of the disclosure;

FIG. 4 shows subcomponents of a head movement tracker, according to an embodiment of the disclosure;

FIG. 5 show subcomponents of a focus detection component, according to an embodiment of the disclosure;

FIG. 6 shows a plurality of capturing devices, according to an embodiment of the disclosure; and

FIGS. 7 and 8 show example uses, according to an embodiment of the disclosure; and

FIG. 9 is an embodiment of a general purpose computer that may be used in connection with other embodiments of the disclosure to carry out any of the above-referenced functions and/or serve as a computing device for endpoint(s).

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

Not everyone gets the much envied 50-yard line tickets at a college or professional football game. And, not everyone has the time in their schedule to attend the wedding of a friend of loved ones or a concert from their favorite band. Moreover, the videos of such events don't actually substitute for actually being at the actual event. The viewer of the videos must watch what the cameraman or producer viewed important.

Given concerns such as these, embodiments of the disclosure provide a system that emulates the switching of information one chooses to see, for example, based on movement of their head and eyes, but at a distance from the actual event. According to particular embodiments of the disclosure, the switched information provided to the user may be the next best thing to actual being at the event (or perhaps even better because of rewind capability). According to particular embodiments, the information can be played back in real time, later played back, and even rewound for a selection of a different view than selected the first time.

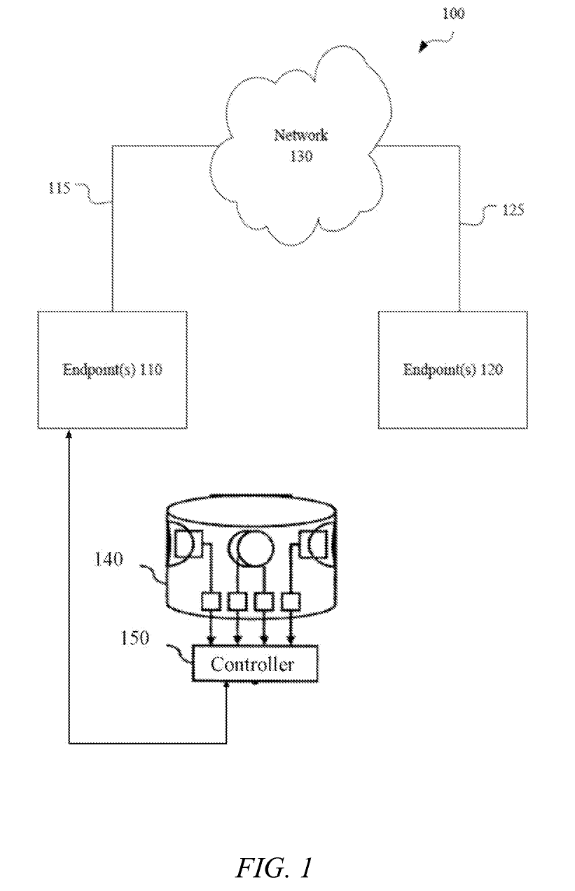

FIG. 1 is a simplified block diagram illustrative of a communication system 100 that can be utilized to facilitate communication between endpoint(s) 110 and endpoint(s) 120 through a communication network 130, according to particular embodiments of the disclosure. As used herein, “endpoint” may generally refer to any object, device, software, or any combination of the preceding that is generally operable to communicate with another endpoint. In certain configurations, the endpoint(s) may represent a user, which in turn may refer to a user profile representing a person. The user profile may comprise, for example, a string of characters, a user name, a passcode, other user information, or any combination of the preceding. Additionally, the endpoint(s) may represent a device that comprises any hardware, software, firmware, or combination thereof operable to communicate through the communication network 130. The communication system 100 further comprises an imaging system 140 and a controller 150.

Examples of an endpoint(s) include, but are not necessarily limited to, a computer or computers (including servers, applications servers, enterprise servers, desktop computers, laptops, netbooks, tablet computers (e.g., IPAD), a switch, mobile phones (e.g., including IPHONE and Android-based phones), networked televisions, networked watches, networked glasses, networked disc players, components in a cloud-computing network, or any other device or component of such device suitable for communicating information to and from the communication network 130. Endpoints may support Internet Protocol (IP) or other suitable communication protocols. In particular configurations, endpoints may additionally include a medium access control (MAC) and a physical layer (PHY) interface that conforms to IEEE 801.11. If the endpoint is a device, the device may have a device identifier such as the MAC address and may have a device profile that describes the device. In certain configurations, where the endpoint represents a device, such device may have a variety of applications or “apps” that can selectively communicate with certain other endpoints upon being activated.

The communication network 130 and links 115, 125 to the communication network 130 may include, but are not limited to, a public or private data network, a local area network (LAN), a metropolitan area network (MAN), a wide area network (WAN), a wireline or wireless network (e.g., WIFI, GSM, CDMA, LTE, WIMAX, BLUETOOTH or the like), a local, regional, or global communication network, portions of a cloud-computing network, a communication bus for components in a system, an optical network, a satellite network, an enterprise intranet, other suitable communication links, or any combination of the preceding. Yet additional methods of communications will become apparent to one of ordinary skill in the art after having read this specification. In particular configuration, information communicated between one endpoint and another may be communicated through a heterogeneous path using different types of communications. Additionally, certain information may travel from one endpoint to one or more intermediate endpoint before being relayed to a final endpoint. During such routing, select portions of the information may not be further routed. Additionally, an intermediate endpoint may add additional information.

Although endpoint generally appears as being in a single location, the endpoint(s) may be geographically dispersed, for example, in cloud computing scenarios. In such cloud computing scenarios, and endpoint may shift hardware during back up. As used in this document, “each” may refer to each member of a set or each member of a subset of a set.

When the endpoints(s) 110, 120 communicate with one another, any of a variety of security schemes scheme may be utilized. As an example, in particular embodiments, endpoint(s) 110 may represent a client and endpoint(s) 120 may represent a server in client-server architecture. The server and/or servers may host a website. And, the website may have a registration process whereby the user establishes a username and password to authenticate or log in to the website. The website may additionally utilize a web application for any particular application or feature that may need to be served up to website for use by the user.

According to particular embodiments, the imaging system 140 and controller 150 are configured to capture and process multiple video and/or audio data streams and/or still images. In particular configurations as will be described below, imaging system 140 comprises a plurality of low latency, high-resolution cameras, each of which is capable of capturing still images or video images and transmitting the captured images to controller 150. By way of example, in one embodiment, imaging system 140 may include eight (8) cameras, arranged in a ring, where each camera covers 45 degrees of arc, to thereby provide a complete 360 degree panoramic view. In another embodiment, imaging system 140 may include sixteen (16) cameras in a ring, where each camera covers 22.5 degrees of arc, to provide a 360 degree panoramic view.

In an example embodiment, one or more of the cameras in imaging system 140 may comprise a modification of an advanced digital camera, such as a LYTRO ILLUM™ camera (which captures multiple focal lengths at the same time), and may include control application that enable zooming and changing the focus, depth of field, and perspective, after a picture has already been captured. Additional information about the LYTRO ILLUM™ camera may be found at www.lytro.com. Yet other light field cameras may also be used. In particular embodiments, such light field cameras are used to capture successive images (as frames in a video) as opposed to one image at a time.

Either separate from or in conjunction with such camera, a variety of microphones may capture audio emanating towards the sensors from different locations.

In certain embodiment, controller 150 is operable, in response to commands from endpoint 110, to capture video streams and/or still images from some or all of the cameras in imaging system 140. Controller 150 is further configured to join the separate images into a continuous panoramic image that may be selectively sent to endpoint 110 and subsequently relayed to endpoint 120 via communication network 130. In certain embodiments, capture from each of the cameras and microphones is continuous with the controller sending select information commanded by the endpoint. As a non-limiting example, that will be described in more detail below, the endpoint may specify viewing of a focal point at a particular angle. Accordingly, the controller will stream and/or provide the information corresponding to that particular focal point and angle, which may including stitching of information from more than one particular camera and audio gathered from microphones capturing incoming audio.

In an advantageous embodiment, a user of endpoint 120 may enter mouse, keyboard, and/or joystick commands that endpoint 120 relays to endpoint 110 and controller 150. Controller 150 is operable to receive and to process the user inputs (i.e., mouse, keyboard, and/or joystick commands) and select portions of the continuous panoramic image to be transmitted back to endpoint 120 via endpoint 110 and communication network 130. Thus, the user of endpoint 110 is capable of rotating through the full 360 degree continuous panoramic image and can further examiner portions of the continuous panoramic image in greater detail. For example, the user of endpoint 110 can selectively zoom one or more of the cameras in imaging system 140 and may change the focus, depth of field, and perspective, as noted above. Yet other more advanced methods of control will be described in greater detail below with reference to other figures.

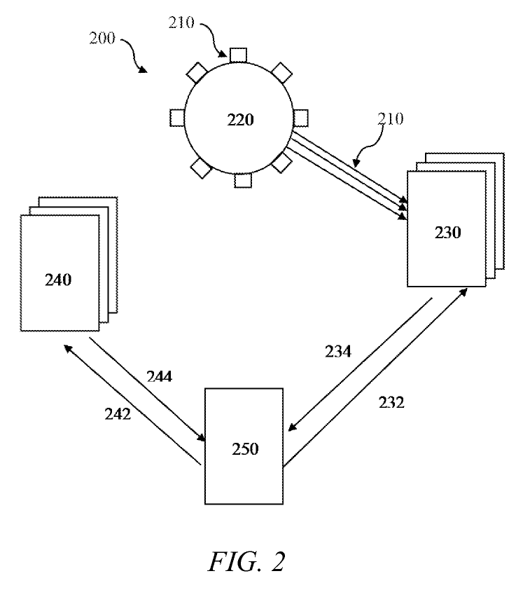

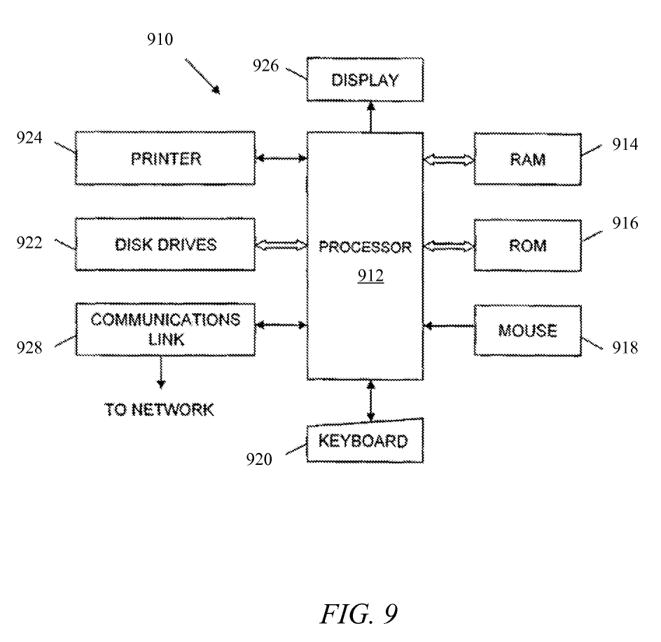

FIG. 2 is a simplified system, according to an embodiment of the disclosure. The system may use some, none, or all of the components described with reference to FIGS. 1 and 9. Additionally, although a particular simplified discussion of components will be described, one should recognize that more, less, or fewer components may be used in operation.

The system of FIG. 2 includes a capturing device 200. The capturing device 200 has been simplified for purposes of illustration. The capturing device 200 in this view generally show a plurality of sensors 210 mounted on a cylindrical shape 220. Although a cylindrical shape 220 is shown for this simplified illustration, a variety of other shapes may also be utilized. For example, the sensors 210 may be mounted around a sphere to allow some of the angles that will be viewed according to embodiments of the disclosure. Additionally, although only eight sensors 210 are shown, more than or less than eight sensors 210 may be used. In particular configurations, thousands of sensors 210 may be placed on the shape 220. Additionally, the sensors 210 may be aligned in rows. For example, the sensors 210 may be considered a cross section for one row of sensors 210 aligned along a column—extending downward into the page. Moreover, the sensors 210 may only surround portions of a shape—if only information from a particular direction is desired. For example, the field of view of gathered information may along be along an arc that extends 135 degree. As another example, the field of view may be along half of an oval for 180 degrees. Yet other configurations will become apparent to readers after review of this specification.

In particular embodiments, multiple cameras may be pointed at the same location to enhance the focal point gathering at a particular angle. For example, a first light field camera may gather focal points for a first optimum range, a second light field camera may gather focal points at a second optimal range, and a third light field camera may gather focal points for a third optimal range. Thus, as a user who chooses to change the reception of information at different focal points, may receive information from different cameras as they modify the focal points they choose to select. The same multiple camera for multiple focal point concept may also be used in scenarios where non-light field camera are used, for example, instead using cameras with relatively fixed focal points and switching between cameras as a different focal point is used. In the switching between cameras of different focal points (using light field cameras or not), stitching may be used to allow a relatively seamless transition. In particular embodiments, such stitching may involve digitally zooming on frames of images (the video) and then switching to a different camera. To enhance such seamless stitching, a variety of image matching technologies may be utilized to determine optimal points at which to switch cameras.

In particular configurations, the capturing device 200 may be stationary. In other configurations, the capturing device may be mobile. As a non-limiting example, the capturing device 200 may be mounted on an air-borne drone or other air-borne device. As another example, the capturing device may be mounted on a remotely controlled vehicle to survey an area. As yet another example, the capturing device may be mounted on a suspended wire system that are typically used in sporting events such as football.

In some configurations, the surveillance—either airborne or not—may be of a dangerous area. As non-limiting examples, one or more capturing devices may be placed on a robot to monitor a hostage situation. One or more capturing devices may also be placed at crime scenes to capture the details that may later need to be played back and reviewed over and over for details.

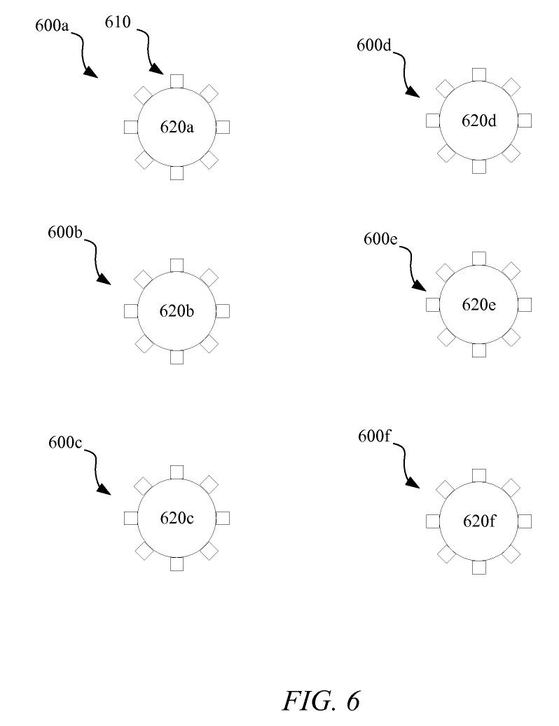

Although one capturing device 200 has been shown, more than one capturing device 200 may exist with switching (and stitching) between such capturing devices 200. For example, as will be described below with reference to FIG. 6 in scenarios involving panning, a user may virtually move from capturing device to capturing device.

The sensors 210 may be any suitable sensors configured to capture reflected light which, when combined, forms images or video. As a non-limiting example, as described above, modified LYTRA cameras may be utilized to capture light at multiple focal points over successive frames for video. In other embodiments, other types of cameras, including light field cameras, may also be utilized with cameras capturing different focuses. In yet other embodiments, non-multiple—focus-at-the-same-time gathering cameras may also be used. That is, in other embodiments, cameras that have a particular focal point (as opposed to more than one) may be utilized.

Although the sensors 210 are generally shown as a single box, the box for the sensor 210 may represent a plurality of sensors that can capture multiple things. As a non-limiting example, a single LYTRA camera may be considered multiple sensors because of gathering light from multiple focal points.

In addition to light, the sensors 210 may capture audio from different angles. Any suitable audio sensors may be utilized. In particular embodiments, the audio—in similar fashion to the light sensors—may be directed to capture audio at different distances using different sensors.

The information captured by the capturing device 200 is sent to one or more servers 230. The one or more servers 230 can process the information for real-time relay for select portions to a viewing device 250. In alternative configurations, the one or more servers 230 can store the information for selective playback and/or rewind of information. As a non-limiting example, a viewer of a sports event may select particular view in a live stream and then rewind to watch a certain event multiple times to view such an event from different angles and/or focus.

In one particular configuration, the server 230 pieces together the various streams of information that have been sent from the capturing device 200 (or multiple capturing devices 200) that the viewing device 250 has requested. As a non-limiting example, the viewing device 250 may wish to view images or video (and audio) from a particular angle with a particular pitch at a particular focal point. The server 230 pulls the information the sensors 210 capturing such information and sends it to the viewing device 250. In some configurations, the relay of information may be real-time (or near real-time with a slight delay). In other configurations, the playback may be of information previously recorded. In addition to information switching from a particular capturing device 200 in particular configurations, the one or more servers 230 may also switch between different capturing devices 200 as will be describe with reference to FIG. 6.

In particular configurations, the information may be stitched—meaning information from more than one sensor is sent. As a simple example, an angle between two or more cameras may be viewed. The information from such two more cameras can be stitched to display a single from such multiple sensors. In particular configurations, stitching may occur at the one or more servers 230. In other configurations, stitching may occur at the viewing device 250.

In particular configurations, the stream of information stitching and relaying may be analogous to a function performed by a human eye when incoming light is switched to focus on a particular light stream. When audio is combined to this light switching, the viewed information may take on appearance as though one were actually present at the same location as the capturing device 200. Other switching of information may be analogous to eye and/or head movement of a user

The applications of the viewing of information captured by capturing devices 200 are nearly unlimited. As non-limiting examples, the capturing devices 200 can be placed at select locations for events—whether they be sporting events, concerts, or lectures in a classroom. Doctors and physicians may also use mobile versions of capturing devices 200 to virtually visit a patient remotely. Police enforcement may also use mobile versions of the capturing devices 200 (or multiple ones) to survey dangerous areas. Yet additional non-limiting examples will be provided below.

Any of the above-referenced scenarios may be viewed in a real-time (or near real-time) or recorded playback scenario (or both). For example, in watching a sport event (real-time or not), a user may pause and rewind to watch the even from a different angle (or from a different capturing device 200) altogether. Police may view the scene—again—looking at clues from a different angle or focus than previously viewed before.

The one or more servers 240 represent additional information that may be displayed to a user. In one configuration, the one or more servers 240 may display an augmented reality. In yet other configurations, only information from the one or more servers 240 may be displayed.

The viewing device 250 may be any suitable device for displaying the information. Non-limiting examples include glasses, projected displays, holograms, mobile devices, televisions, a computer monitors. In yet other configurations, the viewing device 250 may be a contact lens placed in one eyes with micro-display information. The request (generally indicated by arrow 232) for particular information 234 may be initiated in a variety of different manners—some of which are described below.

As a first non-limiting example, the viewing device 250 may be glasses that are opaque or not. The glasses may be mounted with accelerometers, gyroscopes, and a compass (or any other suitable device such an inertial measurement units or IMUS) to detect the direction one's head (or in some scenarios eyes) is facing. Such detected information can switch toward the collection of information in a particular direction. To obtain a particular focus of information, one may use hand gestures that are detected by the glasses. Alternatively, the glasses can include a sensor to detect whether the eye is searching for a different focus and switch to such particular focus. Other devices for switching the input to the glasses may also be utilized.

In other configurations, yet other detection mechanisms may be included using input devices or hand gestures. As a non-limiting example, Meta (www.getmeta.com) has developed glasses with sensors to detect hand movement with respect to such glasses. Such glasses can be augmented to switch streams being captured (or previously captured) from one or more capturing devices. Any other technologies using reflected waves, image analysis of hands with pre-sets for a particular skeletal make-up of a user may also be utilized according to embodiments of the disclosure.

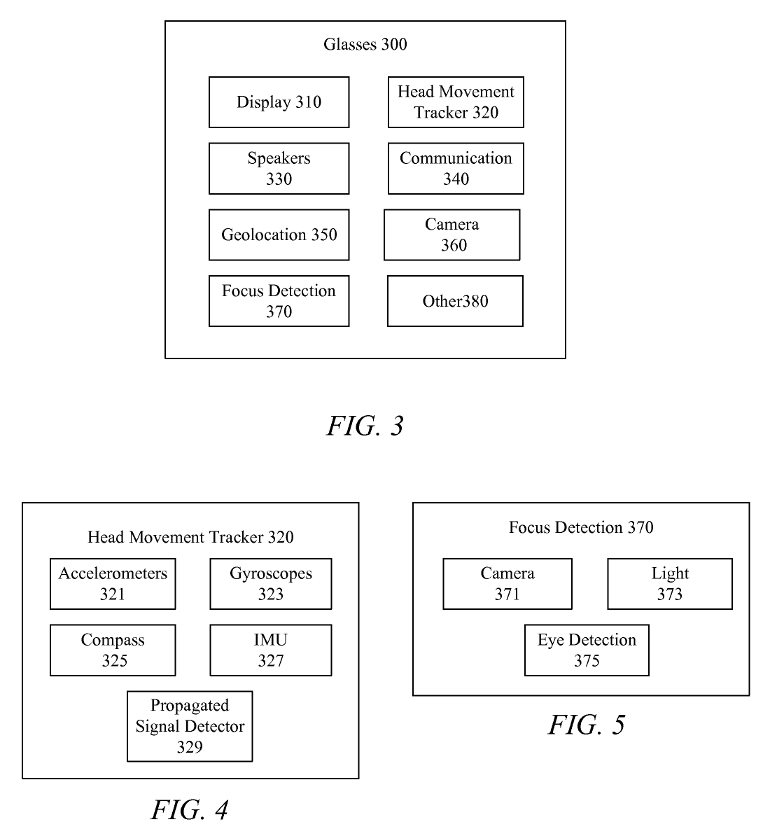

For other types of viewing devices 250 any suitable mechanism to switch the information stream may be utilized—including those mentioned above. For example, a standard tablet or smartphone can be moved around to view different views as though one was actually at the event. Accelerometers, gyroscopes, compasses and other tools on the smart phone may be used to detect orientation. Yet other components will be described below with reference to FIG. 3.

In one particular configuration, the viewing device may be a band worn the arm that projects a display onto one's arm. The interruption in long-range proximity sensors detects changes. A non-limiting example of a band such as this is being developed by Circet, www.circet.com.

In particular configurations, in addition to the information captured by the capturing device 200 being displayed, information from the one more servers 240 may be displayed to augment the remotely-captured real-time (or near real-time) or previously recorded reality is. As a non-limiting example, one watching sporting event may watch a particular player and inquire as to such a player's statistical history. One or a combination of the viewing device 250, the one or more servers 230, and/or the one or more servers 240 may utilize any suitable technology to determine what a particular user is viewing and also to detect the inquiry. The requested information (generally indicated arrow 242) for the return of information 244. A verbal request may be recognized by one or a combination of the viewing device 250, the one or more servers 230, and/or the one or more servers 240.

In other configurations, information may be automatically displayed—in an appropriate manner. For example, in a football game, a first down maker may be displayed at the appropriate location.

In yet other configurations, standard production overlays may be displayed over a virtual (e.g., score of the game, etc.). These can be toggled on or off

As another example of use of information from both the one or more servers 230 and one or more servers 240, a professor may give a lecture on an engine with the professor, himself, viewing the engine as an augmented reality. The wearer of the glasses may view the same engine as an augmented remote reality—again recorded or real-time (or near real-time) with a choice of what to view.

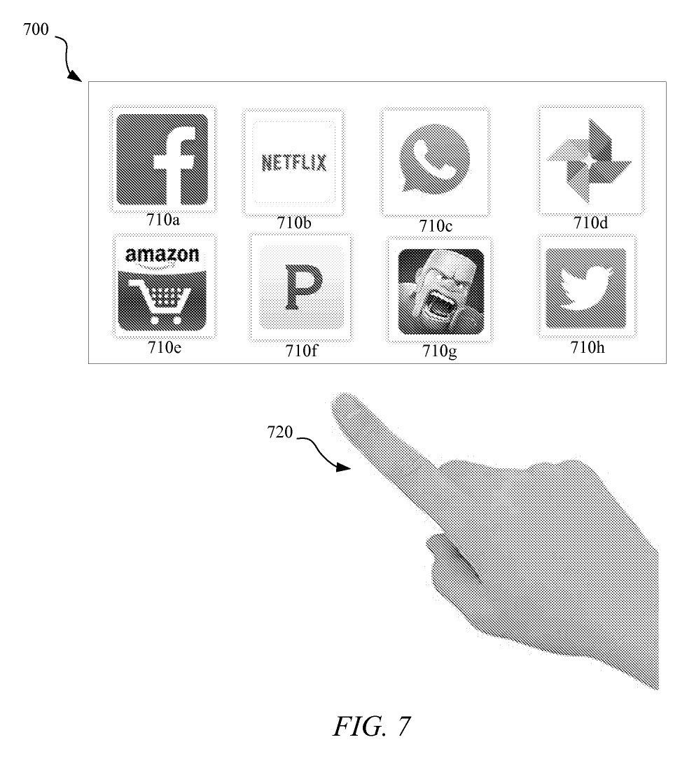

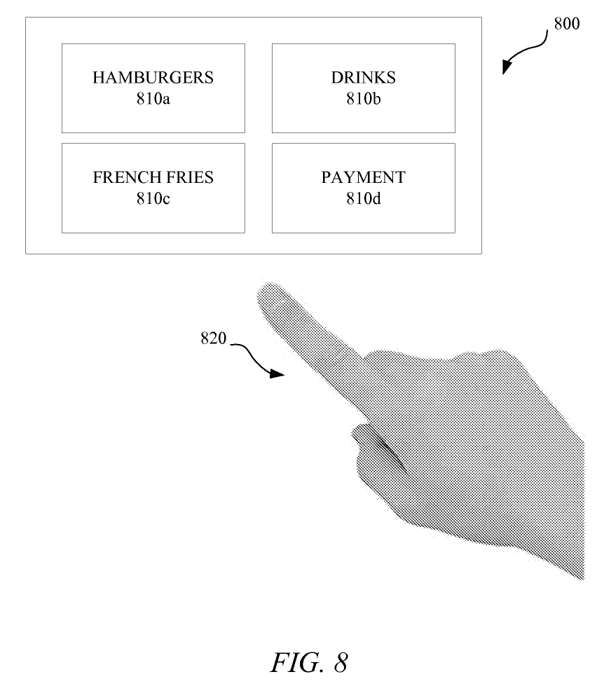

In particular configurations, only information from the one or more servers 240 is utilized forming an “Internet Wall” of sorts to allow a viewer to look at information. In such a configuration, where the viewing device 250 is glasses, a user can viewing information over the internet through various different windows. Additionally, the users can have application—just like on a smartphone. However, the initiation of such applications can effectively be a typing or gesturing the in the air. Further details of this configuration will be described below with reference to FIGS. 7 and 8.

In such configurations as the preceding paragraph, there is little fear of one viewing over your shoulder. The user is the only one able to see the screen. Thus, for example, when in a restaurant or on a plane, there is little fear that one will see private conversations or correspondence.

As yet another example, a user may be wearing the glasses while driving down the road and order ahead using a virtual menu displayed in front of him or her. The user may also authorize payment through the glasses. Non-limiting examples of payment authorization may be a password provided through the glasses, the glasses already recognizing the retina of the eye, or a pattern of the hand through the air. Thus, once the user arrives at a particular location, the food will be ready and the transaction will already have occurred.

FIG. 3 provides non-limiting examples of glasses, according to an embodiment of the disclosure. The glasses 300 of FIG. 3 is one non-limiting example of a viewing device 250 of FIG. 2.

The glasses 300 of this embodiment is shown as including the following components: display 310, head movement tracker 320, speakers 330, communication 340, geolocation 350, camera 360, focus detection 370, and other 380. Although particular components are shown in this embodiments, other embodiments may have more, fewer, or different amounts of components.

The display 310 component of the glasses 300 provides opaque and/or transparent display of information to a user. In particular configurations, the degree of transparency is configurable and changeable based on the desired use in a particular moment. For example, where the user is watching a sporting event or movie, the glasses can transform to an opaque or near-opaque configuration. In other configurations such as augmented reality scenarios, the glasses can transform to a partially transparent configuration to show the portions of the reality that needs to be seen and the amount of augmentation of that reality.

The speakers 330 component provide any suitable speaker that can provide an audio output to a user. The audio may or may not correspond to the display 310 component.

The head movement tracker 320 is shown in FIG. 4 as having a variety of subcomponents: accelerometers 321, gyroscopes 323, compass 325, inertial measurement unit (IMU) 327, and a propagated signal detector 329. Although particular subcomponents of the head movement tracker 320 are shown in this embodiments, other embodiments may have more, fewer, or different amounts of components. In detecting movement of the head (through the glasses which are affixed) any, some, or all of subcomponents may be utilized. In particular configurations, some or all the components may be used in conjunction with one another. For example, in particular configurations, the IMU 327 may include an integrated combination of other subcomponents. A non-liming example of an IMU 327 that may be utilized in certain embodiments is the SparkFun 9 Degrees of Freedom Breakout (MPU-9150) sold by SparkFun Electronics of Niwot, Colo.

The propagated signal detector 329 may use any technique used, for example, by mobile phones in detecting position, but on a more local and more precise scale in particular configurations. For example, the glasses 300 may be positioned in a room with a signal transmission that is detected by multiple propagated signal detectors 329. For example, knowing the position of three propagated signals detectors on the glasses and the relative time difference of their receipt of the signal, the three-dimensional relative position of the glasses 300 can be detected. Although three propagated signal is referenced in the preceding sentence, more than three propagated signal detectors may be utilized to enhance confidence of location. Moreover, although the term relative is utilized, a configuration of glasses upon set-up will determine the relative location for setup.

The other 380 component include any standard components that are typical of smartphones today such as, but not limited to, processors, memory, and the like.

The focus detection 370 component is shown in FIG. 5 as having a variety of subcomponents: camera 371, light emission and detection 373, and eye detectors 375. Although particular subcomponents of the head movement tracker 320 are shown in this embodiments, other embodiments may have more, fewer, or different amounts of components. Additionally, the focus may be detected use some, none or all of these components.

The camera 371 (which may be more than one camera) may either be the same or separate from the camera 360 discussed above. In particular embodiments, the camera 371 may be configure to detect movement of one's hand. As an example, the focus may change based on a particular hand gesture to show the focus is to change (e.g., pinching). Yet other hand gestures may also be used to change focus. In addition to changing focus, the camera 371 may be used to manipulate or change an augmented objects placed in front of the glasses. For example, one may have a virtual engine they are spinning around to view a different view point. In particular embodiments, such different viewpoints may be of a different cameras, for example, in a sporting events or in a reconnaissance type scenario as described herein.

The eye detection 375 component may be used to detect either or both of what and where a user is looking for information—using a sensor such a camera or an autorefractor. In particular embodiments, a focus can change based on changing parameters of the eye as measured by a miniaturized autorefractor. Additionally, when an eye looks in a different direction, a camera can detect the “whites” of one's eye veering in a different direction. Although the eye detection 375 component is used in particular configurations, in other configurations, the other components may be utilized.

The light emission and detection 373 component emits a light for detection of the reflection by the camera or other suitable light detection. A user may place a hand in front of these detectors with gestures such as moving in or moving out to indicate a change of focus. The light emission and detection 373 component and any associated detectors can also be used to determine the direction of one's focus or changing of camera.

FIG. 6 shows a plurality of capturing devices, according to an embodiment of the disclosure. The capturing devices 600a, 600b, 600c, 600d, 600e, and 600f may operate in the same or different manner to the capturing device 200 of FIG. 2 having a plurality of sensors 610 and mounted around a shape 620. FIG. 6 shows how embodiments may have a plurality of capturing devices 600 allowing movement between such device. Although six capturing devices 600 are shown in this configuration, more than or less than six capturing devices may be used according to other embodiments.

As a first non-limiting example, capturing devices 600b and 600e may be positioned on the 50-yard line of a football field. Depending on where game play is occurring, a user may desire to switch capturing devices 600. Any suitable mechanism may be used. For example, a user may place both hands up in front of the glasses and move them in one direction—left or right—to indicate movement between capturing devices. Such a movement may allow a pan switching between capturing device 600b to 600a or 600c. Another non-limiting example, a user may place both hands with a rotational movement to switch to the opposite side of the field, namely from capturing device 600b to 600e. A variety of other hand gestures should become apparent to one reviewing this disclosure.

In switching between one capturing device 600 to another, stitching may also be utilized to allow for relatively seamless transitions.

FIG. 7 shows an example use, according to an embodiment of the disclosure. FIG. 7 shows a virtual screen 700 that may appear in front of a user wearing the glasses 300 of FIG. 3. As described above, this may be viewed as an Internet wall of sorts that allows a user to privately see information in front of them—in an augmented reality type configuration. In particular embodiments where one of the cameras or other components on the glasses is detecting a smooth surface (such as a desk or piece of paper), the virtual screen 700 may be displayed on the smooth surface. In other configurations where the augmented wall is appearing in space in front of the user, the user may be allowed to determine how far in front of him or her the wall is placed.

The particular virtual screen 700 shown in FIG. 7 is an application interface that allows a user to select one of a number of applications 710a, 710b, 710c, 710d, 710e, 710f, 710g, and 710h—according to an embodiment of the disclosure. The user selects the application by simply touching the respective icon on the virtual wall, for example, as illustrated by hand 720 moving towards the virtual screen 700. A virtual keyboard (not shown) can also pop-up to allow additional input by the user.

The virtual screen 700 may take on any of a variety of configurations such as, but not limited to, those provided by a smart phone or computer. Additionally, the virtual screen in particular embodiments may provide any content that a smart phone or computer can provide—in addition the other features described herein. For example, as referenced above, virtual augmented reality models can be provided in certain configurations. Additionally, the remote viewing of information gathered by, for example, one or more capturing devices 200 may also be displayed.

The following provides some non-limiting example configurations for use of the glasses 300 described with reference to FIG. 3.

The glasses 300 maybe provided to visitors of a movie studio; however, rather than the viewers of the movie studio viewing a movie on the big screen, they will be viewing the content they choose to view by interacting with the glasses 300. The content may be any event (such a sporting event, concert, or play). In addition to information from the event, the viewer may choose supplemental content (e.g., statistics for a player, songs for a musician, or other theatrical events for an actor). Alternatively, the content may be a movie shot from multiple perspectives to provide the viewer a completely new movie viewing experience.

The particular configuration in the preceding paragraph may assist with scenarios where a user does not have the particular bandwidth capacity needed, for example, at home to stream content (which in particular configurations can become bandwidth intensive). Additionally, in particular embodiments, all the data for a particular event may be delivered to the movie theater for local as opposed to remote streaming. And, portions of the content are locally streamed to each respective glasses (using wired or wireless configurations) based on a user's selection. Moreover, in the streaming process, intensive processing may take place to stitch as appropriate information gathered from different sources.

In scenarios where bandwidth is adequate, in particular scenarios, a user may be allowed to view the content from home—in an on-demand type scenario for any of the content discussed herein. As referenced above, in such scenarios, stitching (across focus, across cameras, and across capturing devices) may either occur locally or remotely. And, in some configurations, certain levels of pre-stitching may occur.

As another non-limiting example, a user may have receive content from a personal drone that allows view from different elevated perspective. For example, a golfer may place the glasses on to view an overhead of a layout of the course for strategies in determining how best to proceed. In reconnaissance type scenarios, single drone may provide a plurality of personnel “visuals” on a mission—with each person choosing perhaps different things they want to look at.

As another example, a user may place a capturing device 200 on his or self in GO-PRO-style fashion to allow someone else view a plurality of viewpoints that the user, himself would not necessarily view. This information may be either be stored locally or communicated in a wireless fashion.

As yet another example, students in a classroom may be allowed to take virtual notes on a subject with a pen that specifically interoperates with the glasses. In such a scenario, the cameras and/or other components of the glasses can detect a particular plane in front of the glasses (e.g., a desk). Thus, a virtual keyboard can be displayed on the desk for typing. Alternatively, a virtual scratch pad can also be placed on the desk for creating notes with a pen. In such scenarios, a professor can also have a virtual object and/or notes appear on the desk. For example, where the professor is describing an engine, a virtual representation of the engine may show up on the desktop with the professor controlling what is being seen. The user may be allowed to create his or her own notes on the engine with limited control provided by the professor.

As yet another example, deaf people can have a real-time speech-to-text input of interpreted spoken content displayed. Blind people can have an audio representation of an object in front of the glasses—with certain frequencies and/or pitches being displayed for certain distances of the object.

As yet another example, a K-9 robot device can be created with capturing devices mounted to a patrol unit used for security—with audio and visual views much greater than any human or animal. If any suspicious activity is detected in any direction, an alert can be created with enhanced viewing as to the particular location of the particular activity. For example, the K-9 device can be programmed to move toward the suspicious activity.

As yet another example, one given a speech can be given access to his or her notes to operate in a virtual teleprompter type manner.

As yet another example, the glasses may have image recognition type capabilities to allow recognition of a person—followed by a pulling up of information about the person in an augmented display. Such image recognition may tap into any algorithms for example, used by Facebook, in the tagging of different types of people. As a non-limiting example, such algorithms use things such as space between facial features (such as eyes) to detect a unique signature for a person.

As yet another example, the glasses may display a user's social profile page, which may be connected to more than one social profile like Google+, Facebook, Instagram, and Twitter.

As yet another example shown with reference to FIG. 8, a user (but not the driver) heading down the road may use the glasses to make a food order that will be ready upon arrival. A user can be displayed a virtual menu 800 of a variety of selectable items (e.g., hamburgers 810a, french fries 810b, and drinks 810c) and then checkout using any payment of method—indicated by payment button 810d. In particular scenarios, to ensure the food is warm, the location of the glasses and speed of travel can be sent to estimate a time of arrival.

FIG. 9 is an embodiment of a general-purpose computer 910 that may be used in connection with other embodiments of the disclosure to carry out any of the above-referenced functions and/or serve as a computing device for endpoint(s) 110 and endpoint(s) 120. General purpose computer 910 may generally be adapted to execute any of the known OS2, UNIX, Mac-OS, Linux, Android and/or Windows Operating Systems or other operating systems. The general purpose computer3 in this embodiment includes a processor 912, a random access memory (RAM) 914, a read only memory (ROM) 916, a mouse 918, a keyboard 920 and input/output devices such as a printer 924, disk drives 922, a display 926 and a communications link 928. In other embodiments, the general purpose computer 910 may include more, less, or other component parts.

Embodiments of the present disclosure may include programs that may be stored in the RAM 914, the ROM 916 or the disk drives 922 and may be executed by the processor 912 in order to carry out functions described herein. The communications link 928 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 922 may include a variety of types of storage media such as, for example, floppy disk drives, hard disk drives, CD ROM drives, DVD ROM drives, magnetic tape drives or other suitable storage media. Although this embodiment employs a plurality of disk drives 922, a single disk drive 922 may be used without departing from the scope of the disclosure.

Although FIG. 9 provides one embodiment of a computer that may be utilized with other embodiments of the disclosure, such other embodiments may additionally utilize computers other than general-purpose computers as well as general-purpose computers without conventional operating systems. Additionally, embodiments of the disclosure may also employ multiple general-purpose computers 910 or other computers networked together in a computer network. Most commonly, multiple general-purpose computers 910 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 9, the logic includes computer software executable on the general-purpose computer 910. The medium may include the RAM 914, the ROM 916, the disk drives 922, or other mediums. In other embodiments, the logic may be contained within hardware configuration or a combination of software and hardware configurations.

The logic may also be embedded within any other suitable medium without departing from the scope of the disclosure.

It will be understood that well known processes have not been described in detail and have been omitted for brevity. Although specific steps, structures and materials may have been described, the present disclosure may not limited to these specifics, and others may substituted as is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1-14. (canceled)

15. Glasses for selecting a subset of gathered visual data comprising:
a display screen configured to display a subset of light data captured by a plurality of sensors that capture light at different focal points and at different angles;
a focus detection component that conveys a particular focal point for the subset of light data, the focus detection component including an eye detection component configured to detect a desired focal point based on changing shape or size of one or more components of one or more eyes;
a directional detection component that conveys a particular direction for the subset of light data; and
a communication component configured to receive a dynamically changing stream of images from for a video stream for the display screen based on a particular selection of a subset of the light data from a combination of input from the focus detection component and directional detection unit.

16. The glasses of claim 15, wherein the directional detection component comprises one or more of an accelerometer, gyroscopes, compass, inertial measurement unit, or propagated signal detector to detect a particular direction of light data a wearer of the glasses is requesting at a particular moment.

17. The glasses of claim 15, wherein the eye detection component measures a changing shape or size of a retina in the one or more eyes.

18. The glasses of claim 17, wherein the eye detection component comprises an autorefractor.

19. The glasses of claim 15, wherein the eye detection component comprises an autorefractor.

20. The glasses of claim 15, wherein the communication component is further configured to receive user requested information as an overlay over the video stream.

21. The glasses of claim 15, wherein the communication component is further configured to receive information as an overlay over the video stream that is dependent on the determined desired focal point.

22. The glasses of claim 15, wherein the eye detection component comprises one or more cameras that measure the shape or size of the one or more components of one or more eyes.

23. The glasses of claim 15, wherein the directional detection component comprises one or more cameras that measure whites of one or more eyes to determine a direction.

24. The glasses of claim 15, wherein the eye detection component in determining a desired focal point is further configured to manipulate an overlay provided on the display separate from the video stream.

25. The glasses of claim 15, wherein the focus detection component including a gesture detection component configured to detect the desired focal point based on gestures made by an object in front of the glasses.

26. The glasses of claim 25, wherein the desired focal point is determined by combined outputs from the gesture detection component and the eye detection component.

27. Glasses for selecting a subset of gathered visual data comprising:
a display screen configured to display a subset of light data captured by a plurality of sensors that capture light at different focal points and at different angles;
a focus detection component that conveys a particular focal point for the subset of light data, the focus detection component including a gesture detection component configured to detect a desired focal point based on gestures made by an object in front of the glasses;
a directional detection unit that conveys a particular direction for the subset of light data; and
a communication component configured to receive a dynamically changing stream of images from for a video stream for the display screen based on a particular selection of a subset of the light data from a combination of input from the focus detection component and directional detection unit.

28. The glasses of claim 27, wherein the gesture detection component is configured to detect a desired focal point based on gestures made by one or more hands in front of the glasses

29. The glasses of claim 28, wherein the gesture detection component includes a camera to detect the gestures made by the one or more hands.

30. The glasses of claim 29, wherein the gesture detection component includes a light emitter that emits a light for reflection by the one or more hands.

31. The glasses of claim 29 wherein the camera is also configured to detect gestures made by the hands in interacting with an overlay provided in the display separate from the video stream.

32. The glasses of claim 27, wherein the communication component is further configured to receive user requested information as an overlay over the video stream.

33. The glasses of claim 27, wherein the communication component is further configured to receive information as an overlay over the video stream that is dependent on the determined desired focal point.
